(19) United States
(12) Patent Application Publication
(10) Pub. No.: US 2010/0253880 A1
(43) Pub. Date: Oct. 7, 2010

(54) LIGHT GUIDE PLATE, SURFACE-EMITTING APPARATUS, LIQUID CRYSTAL DISPLAY APPARATUS, AND METHOD OF PRODUCING A LIGHT GUIDE PLATE

(75) Inventors: Jun Sasaki, Miyagi (JP); Akihiro Horii, Miyagi (JP); Satoko Asaoka, Miyagi (JP); Kanako Hashimoto, Miyagi (JP); Makoto Aoki, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/726,550

(22) Filed: Mar. 18, 2010

(30) Foreign Application Priority Data
Apr. 1, 2009 (JP) P2009-089469

(51) Int. Cl. G02F 1/1335; F21V 7/22; B23P 25/00

(52) U.S. Cl. 349/64; 362/606; 29/458

(57) ABSTRACT

A light guide plate includes a light-incident surface, a light-reflecting surface, and a light-emitting surface. The light-reflecting surface includes a plurality of first light diffusion portions and a second light diffusion portion. The plurality of first light diffusion portions each have a first concavo-convex height. The second light diffusion portion has a second concavo-convex height lower than the first concavo-convex height and is extended around the plurality of first light diffusion portions in a net-like manner. The light-emitting surface emits light that enters from the light-incident surface and is reflected by the light-reflecting surface.

### CROSS REFERENCES TO RELATED APPLICATIONS

The present application claims priority to Japanese Priority Patent Application JP 2009-089469 filed in the Japan Patent Office on Apr. 1, 2009, the entire content of which is hereby incorporated by reference.

### BACKGROUND

The present application relates to a light guide plate used in an edge-light-type backlight unit, a surface-emitting apparatus and liquid crystal display apparatus equipped with the light guide plate, and a method of producing a light guide plate.

A liquid crystal display apparatus, in particular, a transmission-type liquid crystal display apparatus includes a liquid crystal display panel and a backlight unit as an illumination light source. As backlight units, there is an edge-light type in addition to a direct type in which a light source is disposed right below a liquid crystal display panel. The edge-light-type backlight unit includes a light guide plate disposed on a back surface of the liquid crystal display panel, a light source disposed on a side surface of the light guide plate, a reflector plate that covers a surface on the other side of a light-emitting surface of the light guide plate, and the like.

In the edge-light-type backlight unit, light that has been emitted from a light source enters a light guide plate from a light-incident surface of the light guide plate and propagates inside the light guide plate while repeating a total reflection on a light-emitting surface of the light guide plate and a light-reflecting surface on the opposite side. During the propagation, light is diffused by a diffusion pattern formed on the light-reflecting surface and emitted from the light-emitting surface when an incidence angle with respect to the light-emitting surface becomes a critical angle or less, thus becoming illumination light of the liquid crystal display panel. The diffusion pattern is for uniformly emitting light from the light-emitting surface and is formed so that density of the pattern is low in the vicinity of the light source and is high as a distance from the light source increases. For example, Japanese Patent Application Laid-open No. 2006-210108 discloses a film-like light guide plate in which dot patterns are formed on a back surface of a light-emitting surface by a printing method.

### SUMMARY

In recent years, a liquid crystal display apparatus has been made thinner and a light guide plate constituting a backlight unit is also demanded to become thinner. However, the inventors of the present application have found that, as the light guide plate becomes thinner, a difference in diffusion characteristics between a formation area of a diffusion pattern and a non-formation area of the diffusion pattern becomes obvious in an area in which a formation density of the diffusion pattern is low, and the difference tends to be viewed through a liquid crystal display panel. The above fact causes unevenness in brightness and lowering of a displayed image quality, which needs to be addressed along with achievement of thinning of the light guide plate.

In view of the circumstances as described above, there is a need for a light guide plate capable of suppressing generation of unevenness in brightness along with thinning of the light guide plate, a surface-emitting apparatus and liquid crystal display apparatus equipped with the light guide plate, and a method of producing a light guide plate.

According to an embodiment, there is provided a light guide plate including a light-incident surface, a light-reflecting surface, and a light-emitting surface.

The light-reflecting surface includes a plurality of first light diffusion portions and a second light diffusion portion. The plurality of first light diffusion portions each have a first concavo-convex height. The second light diffusion portion has a second concavo-convex height lower than the first concavo-convex height and is extended around the plurality of first light diffusion portions in a net-like manner.

The light-emitting surface emits light that enters from the light-incident surface and is reflected by the light-reflecting surface.

The first light diffusion portions diffuse light that enters from the light-incident surface and propagates inside the light guide plate while repeating a total reflection on the light-emitting surface and the light-reflecting surface, and emit the light from the light-emitting surface. The second light diffusion portion also has a function of diffusing the light that propagates inside the light guide plate. Here, the second light diffusion portion has a small concavo-convex height as compared to the first light diffusion portions, and therefore the diffusion function thereof is low as compared to the first light diffusion portions. However, since the second light diffusion portion is extended around the first light diffusion portions in a net-like manner, the second light diffusion portion relieves a difference in degree of diffusion between a formation position of the first light diffusion portions and a non-formation position thereof and reduces generation of unevenness in brightness that results from the difference in degree of diffusion. Accordingly, with the light guide plate described above, it is possible to effectively suppress the generation of unevenness in brightness along with achievement of thinning.

The concavo-convex height of the second light diffusion portion can be 300 nm or more and 1,000 nm or less. In a case where the concavo-convex height of the second light diffusion portion is less than 300 nm, a so-called moth-eye effect is expressed with respect to a visible light wavelength and target diffusion characteristics are difficult to be obtained. Moreover, in a case where the concavo-convex height of the second light diffusion portion exceeds 1,000 nm, an influence of a light diffusion effect due to the second light diffusion portion is become strong. As a result, an amount of light that emits from an area in which a formation density of the first light diffusion portions is large is increased as compared to other areas, and thus it becomes difficult to achieve uniformity of brightness characteristics.

Each of the plurality of first light diffusion portions can be one of a circular convex portion and a circular concave portion. In this case, each of the plurality of first light diffusion portions can have a diameter of 50 μm or less. With this structure as well, it is possible to relieve the difference in degree of diffusion between the formation position of the first light diffusion portions and the non-formation position thereof and largely contribute to suppression of unevenness in brightness.

The light guide plate can have a thickness of 300 μm or less. Even when the light guide plate is made thin as described above, it becomes possible to effectively suppress generation of unevenness in brightness due to the difference in degree of diffusion between the formation position of the first light diffusion portions and the non-formation position thereof.

The plurality of first light diffusion portions and the second light diffusion portion can be integrally formed on the light-reflecting surface. Accordingly, it becomes possible to easily form the first and second light diffusion portions on the light-reflecting surface. For example, by using a master having concave portions of shapes corresponding to the first and second light diffusion portions, it is possible to form convex first and second light diffusion portions on the light-reflecting surface.

According to an embodiment, there is provided a surface-emitting apparatus including a light guide plate and a light source.

The light guide plate includes a light-incident surface, a light-reflecting surface, and a light-emitting surface. The light-reflecting surface includes a plurality of first light diffusion portions and a second light diffusion portion. The plurality of first light diffusion portions each have a first concavo-convex height. The second light diffusion portion has a second concavo-convex height lower than the first concavo-convex height and is extended around the plurality of first light diffusion portions in a net-like manner. The light-emitting surface emits light that enters from the light-incident surface and is reflected by the light-reflecting surface.

The light source is disposed facing the light-incident surface of the light guide plate.

According to the surface-emitting apparatus as structured above, it becomes possible to effectively suppress generation of unevenness in brightness along with the thinning of the light guide plate.

According to an embodiment, there is provided a liquid crystal display apparatus including a light guide plate, a light source, and a liquid crystal display panel.

The light guide plate includes a light-incident surface, a light-reflecting surface, and a light-emitting surface. The light-reflecting surface includes a plurality of first light diffusion portions and a second light diffusion portion. The plurality of first light diffusion portions each have a first concavo-convex height. The second light diffusion portion has a second concavo-convex height lower than the first concavo-convex height and is extended around the plurality of first light diffusion portions in a net-like manner. The light-emitting surface emits light that enters from the light-incident surface and is reflected by the light-reflecting surface.

The light source is disposed facing the light-incident surface of the light guide plate.

The liquid crystal display panel is disposed on a light-emitting surface side of the light guide plate.

According to the liquid crystal display apparatus as structured above, it becomes possible to effectively suppress generation of unevenness in brightness along with the thinning of the light guide plate.

According to an embodiment, there is provided a method of producing a light guide plate, including a step of forming a plurality of first light diffusion portions each having a first concavo-convex height on a first surface of a translucent base material. On the first surface, a second light diffusion portion that has a second concavo-convex height lower than the first concavo-convex height and is extended in a net-like manner is formed.

The light guide plate produced as described above includes, on the light-reflecting surface thereof, the first light diffusion portions and the second light diffusion portion that is extended around the first light diffusion portions in a net-like manner. Accordingly, it becomes possible to effectively suppress generation of unevenness in brightness along with the thinning of the light guide plate.

The plurality of first light diffusion portions and the second light diffusion portion can be formed by a transfer method using a master on which a structure having a shape corresponding to the plurality of first light diffusion portions and a structure having a shape corresponding to the second light diffusion portion are formed. Accordingly, it is possible to increase productivity of the light guide plate.

The method of producing a light guide plate may include a step of coating a surface of the master with chrome plating. Accordingly, the structure having the shape corresponding to the second light diffusion portion can be structured by a crack generated in the chrome plating.

The plurality of first light diffusion portions may be formed on the first surface on which the second light diffusion portion is formed. In this case, the plurality of first light diffusion portions can be constituted of a printed layer formed on the first surface by a printing method. The second light diffusion portion can be formed by using the master on which a coating having fine cracks on a surface thereof is formed, for example.

As described above, according to the embodiments of the present application, it becomes possible to suppress generation of unevenness in brightness along with the thinning of the light guide plate.

Additional features and advantages are described herein, and will be apparent from the following Detailed Description and the figures.

### BRIEF DESCRIPTION OF THE FIGURES

FIG. 1 is an exploded perspective view showing a schematic structure of a liquid crystal display apparatus according to an embodiment;

FIG. 2 is a plan view showing a light-emitting surface of a light guide plate constituting the liquid crystal display apparatus;

FIG. 3 is a bottom view showing a light-reflecting surface of the light guide plate;

FIG. 4 is a side view of the light guide plate;

FIG. 5 is a cross-sectional view seen in an (A)-(A) line direction of FIG. 2;

FIG. 6 is an enlarged view of a main part of the light-reflecting surface of the light guide plate;

FIG. 7 is a schematic process diagram for explaining a method of producing a light guide plate according to an embodiment;

FIG. 8 is a cross-sectional view of a main part of a master for molding the light-reflecting surface of the light guide plate;

FIG. 9 is a plan view of a main part of the master;

FIG. 10 is a schematic structural view of a punching press machine for explaining a production step of the light guide plate;

FIG. 11 is an exploded perspective view of the liquid crystal display apparatus, which is used for explaining an action of the light guide plate; and

FIGS. 12 are diagrams showing experimental results for explaining optical characteristics of the light guide plate, in which FIG. 12A shows experimental results in a case where a structure (second light diffusion portion) is not formed on the light-reflecting surface and FIG. 12B shows experimental results in a case where the structure is formed on the light-reflecting surface.

### DETAILED DESCRIPTION

The present application will be described with reference to the drawings according to an embodiment.

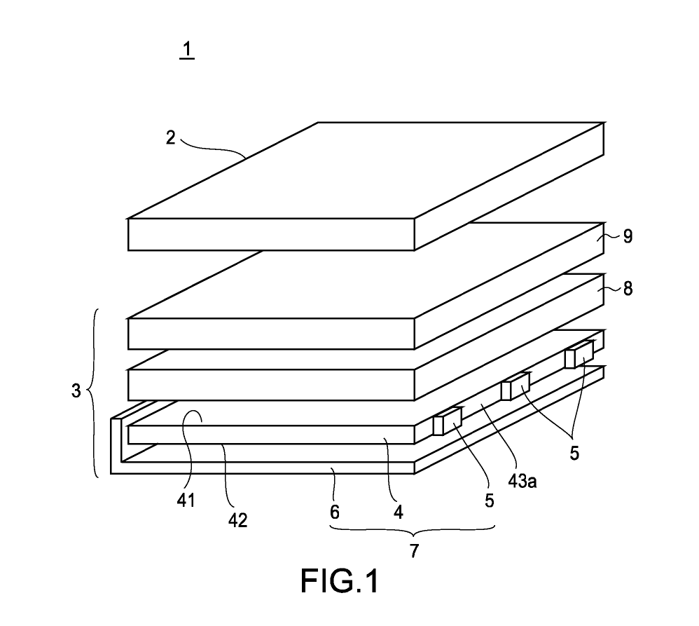

FIG. 1 is a schematic exploded perspective view showing a liquid crystal display apparatus according to an embodiment of the present application. First, the entire structure of a liquid crystal display apparatus 1 will be described.

(Liquid Crystal Display Apparatus)

The liquid crystal display apparatus 1 of this embodiment includes a liquid crystal display panel 2 and a surface-emitting apparatus 3 that illuminates the liquid crystal display panel 2 from a back surface side. The surface-emitting apparatus 3 includes a backlight unit 7 constituted of a light guide plate 4, a light source 5, and a reflector plate 6, and an appropriate optical sheet such as a diffusion sheet 8 and a prism sheet 9.

The liquid crystal display panel 2 has the structure in which a liquid crystal layer is interposed between a pair of transparent substrates. A drive mode of the liquid crystal display panel 2 is not particularly limited, and modes of VA (Vertical Alignment), IPS (In-Plane Switching), TN (Twisted Nematic), and the like are applicable. The liquid crystal display panel 2 includes a first polarizer (polarizing plate) disposed on a light-incident side and a second polarizer (polarizing plate) disposed on a light-emitting side. Further, the liquid crystal display panel 2 includes a color filter (not shown) for displaying a color image. It should be noted that the liquid crystal display panel 2 has the structure including a phase difference film for optically compensating birefringence in the liquid crystal layer or the like as appropriate.

The backlight unit 7 is constituted of an edge-light-type backlight unit. The backlight unit 7 includes the light guide plate 4 made of a translucent material, the light source 5 disposed on a side surface portion of the light guide plate 4, and the reflector plate 6 that covers a surface on the other side of a light-emitting surface of the light guide plate 4, and the like. Examples of the reflector plate 6 include a reflective sheet, a specular metal frame, a highly reflective resin frame of a white color or the like, etc. The light source 5 is constituted of a plurality of point light sources such as LEDs (Light Emitting Diodes), but a line light source such as a fluorescent tube can be used.

The light guide plate 4 includes a light-incident surface 43a that light emitted from the light source 5 enters, a light-emitting surface 41 that is opposed to the diffusion sheet 8, and a light-reflecting surface 42 that is opposed to the reflector plate 6. Light that enters from the light-incident surface 43a propagates inside the light guide plate 4 while repeating a total reflection between an inner surface of the light-emitting surface 41 and an inner surface of the light-reflecting surface 42. A dot pattern as a light diffusion portion is formed at a predetermined position on the light-reflecting surface 42, and light that is diffused by the dot pattern and whose incidence angle with respect to the light-emitting surface 41 is less than a critical angle is emitted toward the diffusion sheet 8 from the light-emitting surface 41. A position or size of the dot pattern is optimized so that light is uniformly emitted from the light-emitting surface 41. In this manner, the light guide plate 4 is structured as a surface-emitting body.

(Structure of Light Guide Plate)

Next, the light guide plate 4 will be described in detail.

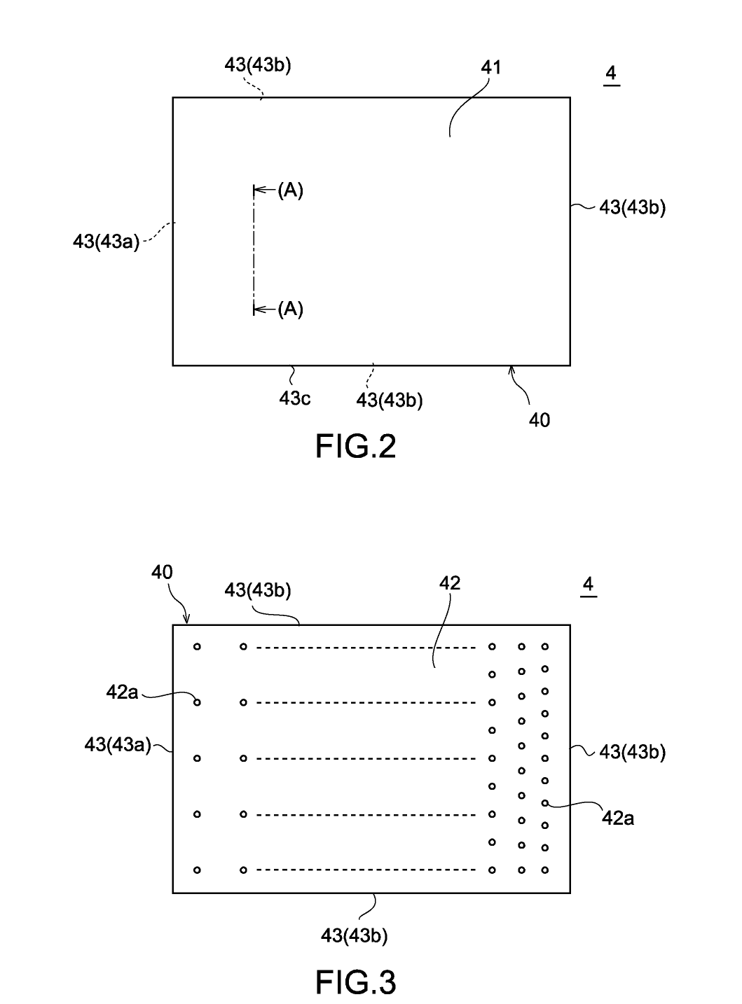

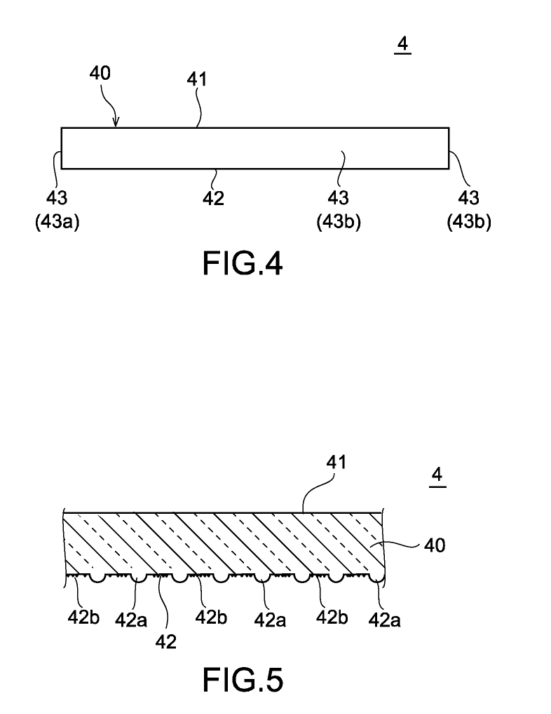

FIG. 2 is a plan view of the light guide plate 4, FIG. 3 is a bottom view of the light guide plate 4, FIG. 4 is a side view of the light guide plate 4, and FIG. 5 is a cross-sectional view taken along the line (A)-(A) of FIG. 2. The light guide plate 4 is formed of a transparent plastic material such as a polycarbonate resin and an acrylic resin. In this embodiment, the light guide plate 4 is produced by punching out a plastic sheet of the transparent resin material described above in a predetermined size. A size of the light guide plate 4 can be set appropriately and is set to 67 mm wide and 35 mm long, for example. A thickness of the light guide plate 4 is set to, for example, 300 μm or less and in this embodiment, 250 μm.

As shown in FIGS. 2 to 4, the light guide plate 4 is constituted of a thin plate including a light guide portion 40 serving as a main body of the light guide plate, the light-emitting surface 41, the light-reflecting surface 42, and four side surfaces 43. The light-emitting surface 41 and the light-reflecting surface 42 correspond to two main surfaces of the light guide plate 4 that are opposed to each other. Out of the four side surfaces 43 of the light guide plate 4, one surface corresponds to a first side surface that becomes the light-incident surface 43a and the other three surfaces correspond to second side surfaces 43b other than the light-incident surface 43a. The light-incident surface 43a may be a short-side side surface of the light guide plate 4 or may be a long-side side surface thereof. The light-reflecting surface 42 and the three side surfaces 43b except the light-incident surface 43a of the light guide plate 4 are covered by the reflector plate 6. It should be noted that the light-incident surface 43a side may also be covered by the reflector plate 6.

The light-emitting surface 41 of the light guide plate 4 is formed as a flat surface as shown in FIGS. 2 and 5, but is not limited thereto. The light-emitting surface 41 may be formed with a prism pattern for the purpose of imparting a light diffusion effect to the light-emitting surface 41. In this case, many prism patterns are arranged in a direction parallel to one side surface 43 that becomes the light-incident surface 43a. The prism patterns may be formed across the entire area of the light-emitting surface 41, or formed partially on the light-emitting surface 41. Further, the present application is not limited to the prism pattern, and other light diffusive patterns such as a toroidal lens pattern and a lens array pattern may be adopted.

On the other hand, the light-reflecting surface 42 of the light guide plate 4 has a function of reflecting light that has entered from the light-incident surface 43a and passed through the light guide portion 40 toward the light-emitting surface 41 side. As shown in FIGS. 4 and 5, a plurality of dot patterns 42a each having a curved convex portion are formed on the light-reflecting surface 42. The dot patterns 42a are formed as diffusion portions (first light diffusion portions) that diffuse light reflected by the light-reflecting surface 42. Light that has entered the dot patterns 42a partially enters at an incidence angle that is less than a critical angle satisfying a total reflection condition with respect to the light-emitting surface 41, thus being emitted from the light-emitting surface 41. The dot patterns 42a are formed with higher density so that formation intervals therebetween become short as a distance thereof from the light-incident surface 43a increases.

The shape and the concavo-convex height of the dot patterns 42a are not particularly limited, and the dot patterns 42a only need to have a size by which the diffusion effect described above can be obtained. In this embodiment, each of the dot patterns 42a is circular, and a diameter thereof is, for example, 20 μm or more to 70 μm or less and the concavo-convex height thereof is 10 μm or more to 35 μm or less. The dot patterns 42a are not limited to the convex type and may be a concave type or combination of the convex type and the concave type.

The size of the dot patterns 42a can be determined in relation to the thickness of the light guide plate 4. For example, in a case where each of the dot patterns 42a is circular and has a diameter of 50 μm or less, a ratio of the diameter of the dot pattern 42a to the thickness of the light guide plate 4 can be set to 20% or less.

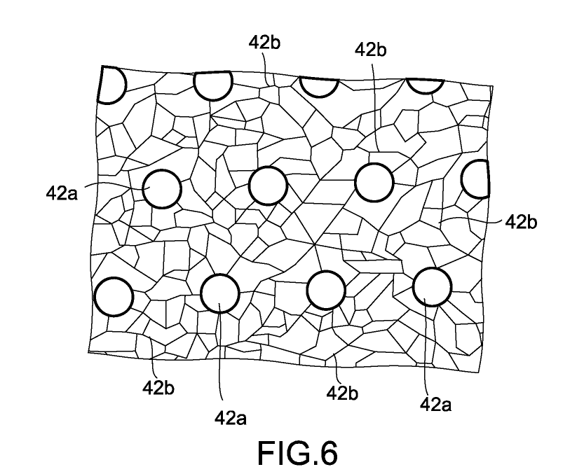

As shown in FIG. 6, the light-reflecting surface 42 of the light guide plate 4 further includes a structure 42b that is extended in a net-like manner around the individual dot patterns 42a. A shape of meshes is irregular and a size thereof is also random. The structure 42b is constituted of streak-like convex portions that extend while branching in a random direction on the light-reflecting surface 42. A height of the structure 42b (concavo-convex height) is lower than that of the dot patterns 42a and is 300 nm or more to 600 nm or less, for example. The height of the structure 42b is not necessary to be uniform and may be different in each area. The structure 42b has a cross section of a substantially triangular shape but is of course not limited thereto.

The structure 42b functions as a light diffusion portion for diffusing light that has entered the light-reflecting surface 42 (second light diffusion portion) as in the case of the dot patterns 42a. Since the concavo-convex height of the structure 42b is much smaller than that of the dot patterns 42a, the structure 42b produce a less light diffusion effect than the dot patterns 42a. In this regard, in this embodiment, the structure 42b is extended in a net-like manner so as to surround the dot patterns 42a as described above, thus relieving a difference in diffusion characteristics between a formation position of the dot patterns 42a and a non-formation position of the dot patterns 42a. Accordingly, it is prevented that the dot patterns 42a are viewed through the panel 2 along with the thinning of the light guide plate 4.

As described above, the height of the structure 42b is needed to be set to a height by which the difference in diffusion characteristics between the formation position of the dot patterns 42a and the non-formation position of the dot patterns 42a can be relieved, and is set to a range of, for example, 300 nm or more to 1,000 nm or less. When the height of the structure 42b exceeds 1,000 nm, the light diffusion effect by the structure 42b acts largely and an amount of light that is emitted from an area having a large formation density of the dot patterns 42a is increased as compared to other areas, for example. In this case, it becomes difficult to obtain uniform brightness characteristics in a plane, which are required for a surface-emitting body.

Moreover, in a case where the height of the structure 42b is less than 300 nm, a so-called moth-eye effect is expressed with respect to a visible light wavelength and target diffusion characteristics are difficult to be obtained. The “moth-eye effect” used herein refers to a reflection prevention function that is expressed when light enters a layer in which a concavo-convex structure (e.g., protrusive structure) is formed in a cycle equal to or smaller than a target light wavelength. Since the concavo-convex structure is recognized by light not as a structure but as a layer whose refractive index changes continuously, an interface reflection is suppressed and a reflection prevention function is expressed.

A formation density of the structure 42b that is formed between the dot patterns 42a can be set as appropriate in accordance with the thickness of the light guide plate 4 and the like, in addition to the size or arrangement interval of the dot patterns 42a. As the formation density of the structure 42b becomes larger, high diffusion characteristics can be obtained at the non-formation position of the dot patterns 42a.

The formation density of the structure 42b used herein refers to, for example, the number of structures 42b per unit area or a size of meshes formed by the structure 42b. In this case, as the number of structures 42b per unit area is larger or as the size of meshes is smaller, the formation density of the structure 42b becomes high.

The formation density of the structure 42b may be uniform over the entire light-reflecting surface 42 of the light guide plate 4 or may be different in each area. For example, the formation density of the structure 42b can be made larger in an area in which the formation density of the dot patterns 42a is lower (area in which arrangement intervals of dot patterns 42a are larger).

The dot patterns 42a and the structure 42b are integrally formed on the light-reflecting surface 42 of the light guide plate 4. As described later, a shape is transferred to a surface of a translucent base material and thus the light-reflecting surface 42 is formed in this embodiment. In this case, a concave pattern having a shape corresponding to the dot patterns and structures described above is formed on a master for transferring the shape to the translucent base material, with the result that the convex dot patterns 42a and structure 42b are simultaneously formed on the light-reflecting surface 42. Accordingly, it is possible to form the dot patterns 42a and the structure 42b with ease.

### Action of this Embodiment

The liquid crystal display apparatus 1 of this embodiment is structured as described above. Next, an action thereof will be described.

Light emitted from the light source 5 enters the light guide plate 4 via the light-incident surface 43a. The light that enters the light guide plate 4 propagates through the light guide portion 40 while repeating a reflex action including a total reflection between the inner surface of the light-emitting surface 41 and the inner surface of the light-reflecting surface 42.

In this embodiment, the dot patterns 42a and the structure 42b are formed on the light-reflecting surface 42. Out of light that reaches the light-reflecting surface 42 from the light guide portion 40, light that enters the dot patterns 42a is diffused in a diffusion mode that is determined by an incident position with respect to the dot patterns 42a. Since this diffused light does not satisfy the total reflection condition with respect to the light-emitting surface 41 in many cases, most diffused light is emitted from the light-emitting surface.

On the other hand, out of the light that reaches the light-reflecting surface 42 from the light guide portion 40, light that enters the non-formation area of the dot patterns 42a is further classified into light that enters the structure 42b and light that does not enter the structure 42b. The light that does not enter the structure 42b refers to light that enters the non-formation position of the structure 42b extended in a net-like manner, that is, an area of meshes. This light is regularly reflected by the flat light-reflecting surface 42. On the other hand, the light that has entered the structure 42b is diffused in a diffusion mode that is determined by an incident position with respect to the structure 42b. Since this diffused light does not satisfy the total reflection condition with respect to the light-emitting surface in many cases, most diffused light is emitted from the light-emitting surface.

In this embodiment, the structure 42b is extended in a net-like manner around the dot patterns 42a. Accordingly, a diffused light is generated so as to surround the dot patterns 42a by the structure 42b. Then, a difference in degree of light diffusion between the formation position of the dot patterns 42a and the non-formation position thereof is relieved. As a result, it is possible to suppress generation of unevenness in brightness that results from the difference in degree of light diffusion. Such an effect can be obviously obtained as the light guide plate 4 is thinner or in an area in which the formation intervals of the dot patterns 42a are larger.

The light emitted from the light-emitting surface 41 of the light guide plate 4 is irradiated onto the liquid crystal display panel 2 via the diffusion sheet 8 and the prism sheet 9 and used as illumination light that displays an image on a front surface of the liquid crystal display panel 2.

As described above, since the structure 42b is extended in a net-like manner so as to surround the dot patterns 42a of the light guide plate 4 in this embodiment, it is possible to relieve the difference in degree of light diffusion between the formation position of the dot patterns 42a and the non-formation position thereof. Accordingly, for example, it is possible to effectively suppress generation of unevenness in brightness at a position corresponding to the formation position of the dot patterns 42a, the unevenness in brightness being viewable on the front surface (display surface) of the liquid crystal display panel 2 along with the thinning of the light guide plate 4.

Consequently, according to this embodiment, it is possible to provide the light guide plate 4 and the surface-emitting apparatus 3 that are excellent in in-plane brightness distribution. In addition, according to this embodiment, it is possible to suppress deterioration of a display image, which can be caused along with the thinning of the light guide plate 4, and thus provide the liquid crystal display apparatus 1 excellent in an image quality.

(Method of Producing Light Guide Plate)

Next, a method of producing the light guide plate 4 according to this embodiment as structured above will be described.

The method of producing the light guide plate 4 according to this embodiment includes a step of forming the dot patterns 42a and the structure 42b on one surface of a translucent base material made of a transparent plastic sheet or the like and a step of forming an outer shape of the light guide plate 4 by punching out the translucent base material in a frame shape. The plastic sheet that becomes a base material of the light guide plate 4 can be produced by various molding methods such as melt extrusion molding, hot-press molding, and roll molding. Further, the plastic sheet may be prepared by purchasing a product commercially available.

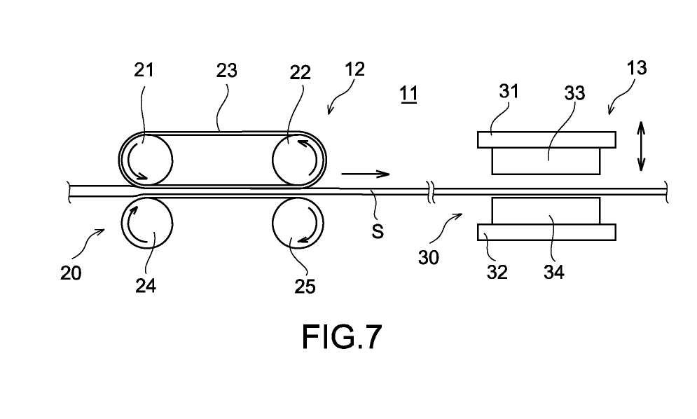

FIG. 7 is a schematic structural diagram of a light guide plate production apparatus 11 used in this embodiment. The light guide plate production apparatus 11 includes a sheet molding portion 12 and a punching press portion 13. The sheet molding portion 12 molds the light-emitting surface 41 and the light-reflecting surface 42 of the light guide plate 4. The punching press portion 13 punches out the plastic sheet molded by the sheet molding portion 12 in a predetermined shape and forms an outer shape (side circumferential surface) of the light guide plate 4.

A molding machine 20 is provided in the sheet molding portion 12. The molding machine 20 includes a heating roll 21, a cooling roll 22, and an endless belt 23 wound around the heating roll 21 and the cooling roll 22. The molding machine 20 also includes a transfer roll 24 opposed to the heating roll 21 and a nip roll 25 opposed to the cooling roll 22. The molding machine 20 forms a long plastic sheet S that has a predetermined thickness (for example, 0.30 mm or less) and whose surface and back surface are each shaped into a necessary shape by supplying a translucent resin material serving as a base material of the light guide plate 4 between the endless belt 23 and the transfer roll 24.

The surface of the plastic sheet S (upper surface in FIG. 7) constitutes the light-emitting surface 41 of the light guide plate 4 and the back surface thereof (lower surface in FIG. 7) constitutes the light-reflecting surface 42 of the light guide plate 4. Here, in a case where the light guide plate 4 having the light-emitting surface 41 as a flat surface is produced, a transfer surface of the endless belt 23 is formed to be flat. Further, in a case where the light-emitting surface 41 is formed as a prism structure surface, the transfer surface of the endless belt 23 is formed by a prism structure surface having a shape corresponding to the above prism structure surface.

On the other hand, the transfer roll 24 forms the lower surface side of the plastic sheet S, which corresponds to the light-reflecting surface 42 of the light guide plate 4. As described above, the light-reflecting surface 42 of the light guide plate 4 includes the plurality of dot patterns 42a and the structure 42b that are extended in a net-like manner. Those dot patterns 42a and structure 42b are simultaneously formed by the transfer roll 24 in the molding step of the plastic sheet S.

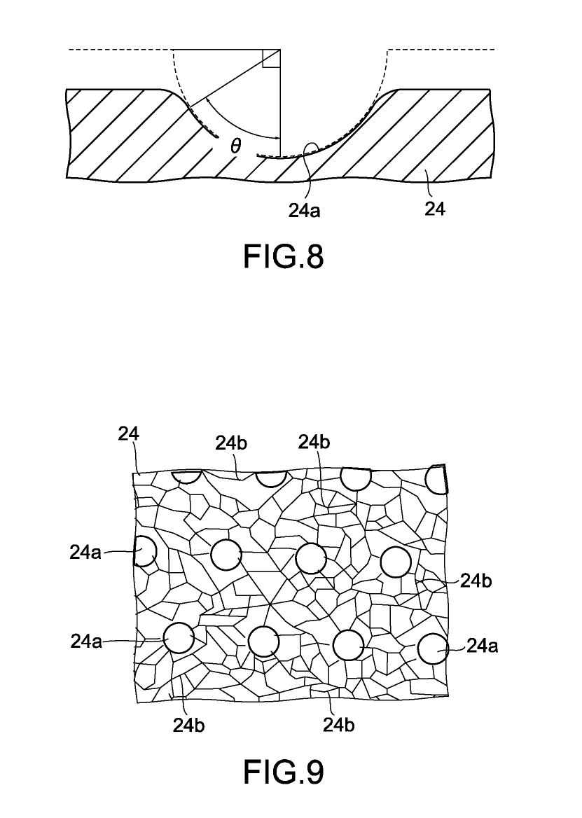

FIGS. 8 and 9 are a cross-sectional side view and a plan view of a main part that show a state of a transfer surface (outer circumferential surface) of the transfer roll 24. The transfer roll 24 includes a plurality of first concave portions 24a for forming the dot patterns 42a and a second concave portion 24b for forming the structure 42b on the back surface of the plastic sheet S. That is, the transfer roll 24 is used as a master for forming the dot patterns 42a and the structure 42b on the back surface of the plastic sheet S.

Each of the first concave portions 24a has a schematically hemispherical cross-section that corresponds to that of the dot pattern 42a. In this embodiment, the first concave portion 24a has a diameter of about 50 μm and a depth of about 20 μm. As shown in FIG. 8, the first concave portion 24a is formed so that a center angle θ of an arc from the center of a bottom portion to a circumferential portion is in a predetermined range. The angle θ is appropriately set in accordance with light diffusion characteristics of required dot patterns 42a and is set to 57.5 degrees to 67.6 degrees in this embodiment. Further, the circumferential portion of the first concave portion 24a may be formed in an appropriate curved shape as shown in the figure.

On the other hand, the second concave portion 24b is formed over the entire outer circumferential surface of the transfer roll 24. The second concave portion 24b may be formed in an area where the first concave portions 24a are formed. In this embodiment, the second concave portion 24b is structured by fine cracks generated on chrome plating that covers the outer circumferential surface of the transfer roll 24.

The chrome plating is a hard coating having high corrosion resistance and is formed on the outer circumferential surface of the transfer roll 24 in order to enhance durability and corrosion resistance thereof. Generally, when chrome plating is formed, fine cracks are generated on a surface due to an internal stress. The cracks propagate across the surface while branching in a random direction, thus taking a shape like a net having an irregular shape. In this embodiment, the structure constituted of the cracks is used as the second concave portion 24b and thus the convex structure 42b having a shape corresponding to the structure is formed on the plastic sheet S.

A depth of the cracks generated on the surface of the chrome plating is controlled in accordance with various formation conditions including a thickness of a plating film. In this embodiment, a master on which those cracks are formed is rolled up in a roll shape, thus forming the transfer roll 24. Accordingly, the depth and width of the cracks after the master is processed in a roll shape become larger than before the processing. In this embodiment, the transfer roll 24 is produced so that the depth of the cracks after the master is processed in a roll shape falls within a range of 300 nm or more to 1,000 nm or less.

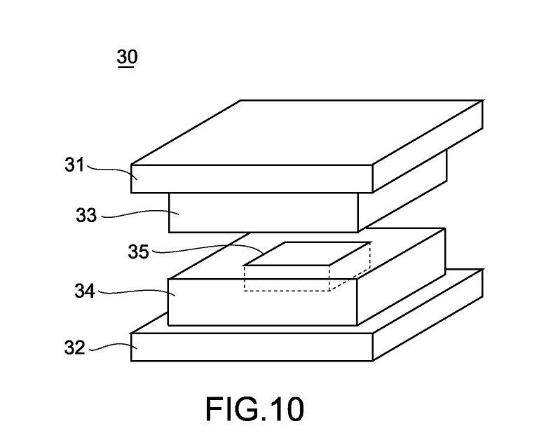

The punching press portion 13 is provided with a punching press machine 30. FIG. 10 is a schematic structural view of the punching press machine 30. The punching press machine 30 includes a movable mold 31 positioned on an upper surface side of the plastic sheet S and a fixed mold 32 positioned on a lower surface side of the plastic sheet S. The movable mold 31 is structured to be movable in a vertical direction with respect to the fixed mold 32. Buffer members 33 and 34 are respectively provided on inner surface sides of the movable mold 31 and the fixed mold 32. A frame-like punching blade (Victoria blade) 35 is embedded in the buffer member 34 on the fixed mold 32 side.

The punching press machine 30 presses the plastic sheet S supplied between the movable mold 31 and the fixed mold 32 in the vertical direction. At this time, the punching blade 35 embedded in the buffer member 34 approaches the plastic sheet S from the lower surface and produces a sheet piece having an outer shape corresponding to the shape of the punching blade 35. The produced sheet piece constitutes the light guide plate 4 of this embodiment.

Since the light guide plate 4 is produced by a punching press method in this embodiment, a super-slim light guide plate 4 having a thickness of, for example, 0.30 mm or less, which is incapable of being produced by an injection molding method, can be produced easily. The punched-out cross section may be used as the light-incident surface 43a as it is. Accordingly, it is possible to reduce production costs of the light guide plate 4 and also largely increase productivity. Moreover, by changing a size of the punching blade 35, it is possible to easily support production of light guide plates corresponding to various screen sizes.

As described above, the light guide plate 4 of this embodiment is produced. According to this embodiment, the light guide plate 4 that includes the dot patterns 42a and the structure 42b extended in a net-like manner around the dot patterns 42a on the light-reflecting surface 42 can be produced easily. Accordingly, for example, it is possible to effectively suppress generation of unevenness in brightness at a position corresponding to the formation position of the dot patterns 42a, the unevenness in brightness being viewable on the front surface (display surface) of the liquid crystal display panel 2 along with the thinning of the light guide plate 4.

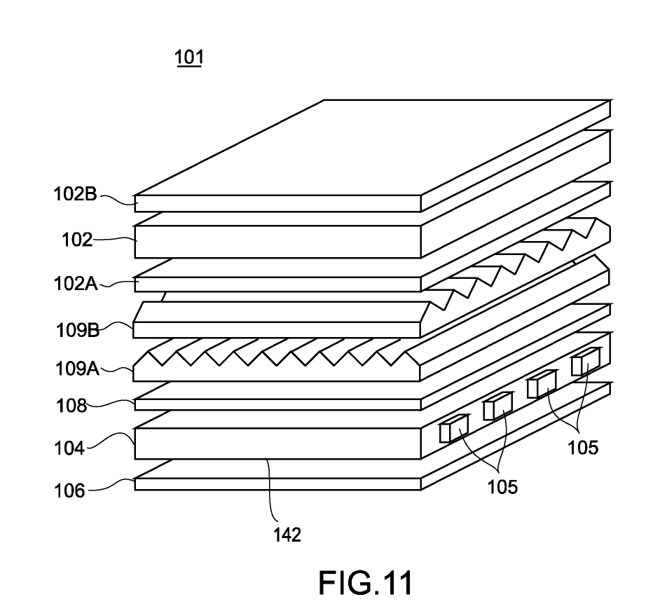

The inventors of the present application produced a plurality of samples of light guide plates that are different in thickness of the light guide plates and in size of a dot pattern, and checked a difference in optical characteristics due to the presence/absence of the structure 42b. FIG. 11 shows a schematic structure of a liquid crystal display apparatus used for the evaluation. A liquid crystal display apparatus 101 shown in FIG. 11 includes a liquid crystal display panel 102, a light guide plate 104, light sources 105, a reflector plate 106, a diffusion sheet 108, and two prism sheets 109A and 109B. The liquid crystal display panel 102 includes first and second polarizers 102A and 102B whose polarizing axes are orthogonal to each other. The prism sheets 109A and 109B each have a prism formation surface facing on the liquid crystal display panel 102 side, and are arranged so that ridge line directions of prism are orthogonal to each other.

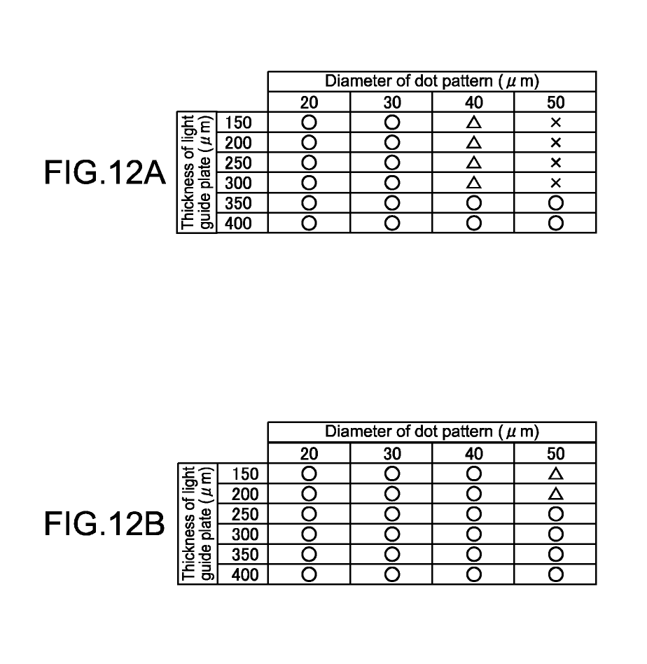

FIG. 12A shows experimental results indicating visibility evaluations of the liquid crystal display panel 102 when a sample in which only dot patterns are formed on a light-reflecting surface 142 is used as the light guide plate 104. In this example, the “visibility” refers to a degree of unevenness in brightness that results from a difference in light diffusion characteristics between a formation position of the dot patterns and a non-formation position thereof and is viewed through the liquid crystal display panel 102. In this example, a sample in which the unevenness in brightness was not recognized is denoted by “∘”, a sample in which the unevenness in brightness was recognized in an allowable range is denoted by “Δ”, and a sample in which the unevenness in brightness exceeding the allowable range was recognized is denoted by “×”.

As shown in FIG. 12A, when the light guide plate becomes thin, visibility is deteriorated as a diameter of the dot pattern becomes larger. In other words, it is possible to prevent the visibility from being deteriorated by reducing the diameter of the dot pattern in accordance with the thinning of the light guide plate. In this example, when the diameter of the dot pattern was 50 μm and 40 μm, the unevenness in brightness was found in the light guide plates having the thickness of 300 μm or less.

It should be noted that those samples were produced using the molding machine described with reference to FIG. 7. In this case, a surface of a transfer roll that becomes a master for molding the light-reflecting surface 142 was coated with nickel plating that is softer than chrome plating. The nickel plating does not cause fine cracks as in the case of the chrome plating. Accordingly, it is possible to produce a light guide plate that does not include structures extended in a net-like manner.

On the other hand, FIG. 12B shows results indicating visibility evaluations when a light guide plate formed using the transfer roll 24 coated with chrome plating was produced. As is apparent from the results of FIG. 12B, in a case where the diameter of the dot pattern is 40 μm, the generation of the unevenness in brightness is suppressed at all thicknesses of the light guide plate. Further, in a case where the diameter of the dot pattern is 50 μm, an effect of reducing the unevenness in brightness was found. This indicates that the difference in light diffusion characteristics between the formation position of the dot patterns 42a and the non-formation position thereof is relieved by the structure (42b) formed on the light-reflecting surface 142 and accordingly the generation of the unevenness in brightness that results from the difference in light diffusion characteristics is effectively reduced.

Up to here, an embodiment has been described, but the present application is of course not limited thereto. The present application can be variously modified based on the technical idea thereof.

For example, in the embodiment described above, the first light diffusion portions (dot patterns 42a) and the second light diffusion portion (structure 42b) are simultaneously formed on the plastic sheet in the same step. Alternatively, the first light diffusion portions may be formed after the second light diffusion portion is formed. In this case, the second light diffusion portion can be formed by, after a flat master on which a hard plating film such as chrome plating is formed is produced, transferring the master to the surface of the plastic sheet. Further, as the first light diffusion portions, the concavo-convex pattern can be formed using a printing technique such as a screen printing method on the surface of the plastic sheet on which the second light diffusion portion has been formed. Accordingly, it is possible to easily form the first light diffusion portions having an appropriate pattern arrangement in accordance with the size of the light guide plate, required optical characteristics, and the like at low costs.

The first light diffusion portions (dot patterns 42a) and the second light diffusion portion (structure 42b) that are formed on the light-reflecting surface of the light guide plate are not limited to those having a convex shape, and may be have a concave shape. In this case, it is only necessary to form convex structures corresponding to the shape of the first and second light diffusion portions on the master for transferring those light diffusion portions.

The transfer mold for molding the second light diffusion portion (structure 42b) is not limited to the master whose surface is coated with chrome plating. For example, a secondary master may be further produced from a primary master coated with chrome plating by using a replica method or an electroforming technique and a mold produced based on the secondary master (tertiary master) may be used. Accordingly, the transfer mold for molding the second light diffusion portion is not limited to the master whose surface is coated with chrome plating.

Production of the light guide plate is not limited to the case of production by the punching press method as described above. For example, the light guide plate may be cut out from the plastic sheet S by using a rotary cutter or the like.

The shape of the light guide plate 4 is not limited to a simple plate shape. For example, the present application can also be applicable to a wedge-shaped light guide plate in which a plate thickness gradually decreases as a distance from an incident surface side increases. Further, the present application can also be applicable to a light guide plate in which an upper surface thereof is formed of a slope portion and a flat portion. With this structure, it is possible to structure a thin light guide plate in which the flat portion is used for a light-emitting surface while setting the thickness of the incident surface in accordance with a size of a light source.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A light guide plate, comprising:
a light-incident surface;
a light-reflecting surface including a plurality of first light diffusion portions each having a first concavo-convex height and a second light diffusion portion that has a second concavo-convex height lower than the first concavo-convex height and is extended around the plurality of first light diffusion portions in a net-like manner; and
a light-emitting surface to emit light that enters from the light-incident surface and is reflected by the light-reflecting surface.

2. The light guide plate according to claim 1,
wherein the second concavo-convex height is 300 nm or more and 1,000 nm or less.

3. The light guide plate according to claim 2,
wherein each of the plurality of first light diffusion portions is one of a circular convex portion and a circular concave portion, and
wherein each of the plurality of first light diffusion portions has a diameter of 50 μm or less.

4. The light guide plate according to claim 3,
wherein the light guide plate has a thickness of 300 μm or less.

5. The light guide plate according to claim 1,
wherein the plurality of first light diffusion portions and the second light diffusion portion are integrally formed on the light-reflecting surface.

6. The light guide plate according to claim 5,
wherein the plurality of first light diffusion portions and the second light diffusion portion are convex portions protruding from the light-reflecting surface.

7. A surface-emitting apparatus, comprising:
a light guide plate including
a light-incident surface,
a light-reflecting surface including a plurality of first light diffusion portions each having a first concavo-convex height and a second light diffusion portion that has a second concavo-convex height lower than the first concavo-convex height and is extended around the plurality of first light diffusion portions in a net-like manner, and
a light-emitting surface to emit light that enters from the light-incident surface and is reflected by the light-reflecting surface; and
a light source that is disposed facing the light-incident surface of the light guide plate.

8. A liquid crystal display apparatus, comprising:
a light guide plate including
a light-incident surface,
a light-reflecting surface including a plurality of first light diffusion portions each having a first concavo-convex height and a second light diffusion portion that has a second concavo-convex height lower than the first concavo-convex height and is extended around the plurality of first light diffusion portions in a net-like manner, and
a light-emitting surface to emit light that enters from the light-incident surface and is reflected by the light-reflecting surface;
a light source that is disposed facing the light-incident surface of the light guide plate; and
a liquid crystal display panel that is disposed on a light-emitting surface side of the light guide plate.

9. A method of producing a light guide plate, comprising:
forming a plurality of first light diffusion portions each having a first concavo-convex height on a first surface of a translucent base material; and
forming, on the first surface, a second light diffusion portion that has a second concavo-convex height lower than the first concavo-convex height and is extended in a net-like manner.

10. The method of producing a light guide plate according to claim 9,
wherein the plurality of first light diffusion portions and the second light diffusion portion are simultaneously formed by a transfer method using a master on which a structure having a shape corresponding to the plurality of first light diffusion portions and a structure having a shape corresponding to the second light diffusion portion are formed.

11. The method of producing a light guide plate according to claim 10, further comprising:
coating a surface of the master with chrome plating,
wherein the structure having the shape corresponding to the second light diffusion portion is a crack generated in the chrome plating.

12. The method of producing a light guide plate according to claim 9,
wherein the plurality of first light diffusion portions are formed on the first surface on which the second light diffusion portion is formed.

13. The method of producing a light guide plate according to claim 12,
wherein the plurality of first light diffusion portions are constituted of a printed layer formed on the first surface by a printing method.

14. The method of producing a light guide plate according to claim 9,
wherein the translucent base material is a transparent plastic sheet,
the method of producing a light guide plate, further comprising:
punching out the transparent plastic sheet in a shape of a frame after the plurality of first light diffusion portions and the second light diffusion portion are formed
